(19) United States
(12) Patent Application Publication
(10) Pub. No.: US 2026/0208922 A1
(43) Pub. Date: Jul. 23, 2026

(54) Cleaning Device with Pouches for Cleaning Materials

(71) Applicant: Eric Ricardo Mendes, Vancouver (CA)

(72) Inventor: Eric Ricardo Mendes, Vancouver (CA)

(21) Appl. No.: 19/027,011

(22) Filed: Jan. 17, 2025

(51) Int. Cl. B65D 33/28; B08B 1/14

(52) U.S. Cl. CPC B65D 33/28; B08B 1/14

(57) ABSTRACT

The preferred embodiment is cloth or sponge material that is folded over and attached on one side, creating a top and bottom, with two sewn lines connecting the top and bottom, a short distance from, and parallel to a closed first end closed and a closed end, with a first end slot and a second end slot, which lie between the sewn lines and the ends, each slot being connected to a cord like material with a loop on the end. When the slot is open cleaning materials may be inserted into the slot and when the loop on the cord like material is pulled the slot is closed and a pouch is formed. The pouches may be used as handles or as a glove, when hands are inserted into the slot. The device can bunched together, by pulling, with a parallel to the sides, cordlike material

### BACKGROUND

Cleaning devices are available for many applications. They can be flat cloths, sponges or balls, or scrubbers of some sort. Cleaning structures in balls offer additional leverage while cleaning cloths work well for flat surfaces. What are not available are cleaning devices that convert from flat cloths to balls, and also elongated cleaning devices that work well for hard to reach areas. This is true for both shower applications, but also includes any application of a hard to reach areas.

### PRIOR ART

Patent U.S. Pat. No. 8,561,250 B2 is an extendable application device which allows a user to apply soap, lotion, medication, or various other substances to areas of the body which may be difficult to reach. The device of U.S. Pat. No. 8,561,250 does not have pouches on either end but pulled tight into an extendable cord and turned into a ball like shape which into which cleaning materials may be added. This device differs from the U.S. Pat. No. 8,561,250 device as this device pouches are on the end of the device, and can be used in the device's non-compressed state. Another key difference between the this application and U.S. Pat. No. 8,561,250 is that U.S. Pat. No. 8,561,250 cord is elastic, which means that it can easily be opened when the device is used as a ball, while the device of this application cordlike material is not elastic, and when closed the pouch will stay closed.

### SUMMARY OF THE INVENTION

The key feature of the product are the pouches on either end which can serve three purposes, they can hold cleaning materials, be used as handles, or be used as cloves, with the person inserting theirs into the pouch to better handle the device. Other important features are the cloth or sponge material and the cordlike material. Both sides of the cloth or sponge material can have different textures (one exfoliating side and one softer side), allowing multiple uses without requiring segmentation or separation. The cordlike material is durable, adjustable, and water-resistant, ensuring practicality and durability. Both the cloth or sponge material and cable like material may have self-cleaning or antibacterial materials added to enhance hygiene and product appeal.

The preferred embodiment is cloth or sponge material that is folded over and attached on one side, with a first end closed and a second end closed, with a first end slot and a second end slot, each slot being connected to a cordlike material with a loop on the end. When the slot is open cleaning materials such as soap may be inserted into the slot and then when the loop on the cordlike material is pulled the slot is closed and a pouch is formed.

“The material used in the cleaning device is comprised of materials suitable for cleaning, exfoliation, and hygiene purposes, which besides sponge material can include, but not limited to, natural, synthetic, or blended materials. All materials used, may include properties such as exfoliating texture, absorbency, antimicrobial effects, or softness for sensitive applications.

The device can be bunched up in order to be turned into a ball like configuration either by compressing the device by hand or by using a parallel to the edge cordlike material that when pulled compresses the device which can then be turned into a ball like configuration either by inserting the bunched up material through the slot or by maneuvering the first or second end around the bunched up material.

The simplest embodiment is a cloth or sponge material that is folded over creating a top and bottom, and attached together on one side of the length of the embodiment, with the first end and the second end sewn shut, exiting the first end through an opening is a long flexible cordlike material that extends out of the first end, and then is terminated at a sewn together portion of the top and bottom that is before a slot near the second end, when the second end is held, and when the cordlike material is pulled it become a ball like configuration after the second end is maneuvered over the bunched up cloth or sponge material. The cleaning device has a length equal to a minimum of five times the width. Additional embodiments add more function to device. Those embodiments are comprised of the following.

A sewn line parallel connecting the top and bottom to the open end a short distance from the open end, with a small opening for the cordlike material, that provides a small distance of material after the cloth material is bunched, to fold over the bunched up cloth material to turn the device into a small ball.

The device stuffed into the slot closest to the second end and the slot is pulled closed with cordlike material that is connected to the slot closes to the second end.

Slots parallel to the first and second ends to allow hands to enter the device.

The ends of the cordlike material being formed into various size loops to more easily handle the cordlike material.

The slots on either end, with or without cordlike drawstrings, that can serve as pouches for soap or other materials in addition to allowing hands to enter and be used for scrubbing and handling of the device.

Both sides of the sponge can have different textures (one exfoliating side and one softer side), allowing multiple uses without requiring segmentation or separation.

The addition of self-cleaning or antibacterial materials to enhance hygiene and product appeal.

### Key Features of the Device

The device incorporates pouches at one or both ends that serve several purposes: to accommodate soaps to facilitate application during bathing; and to allow hands to be inserted into the device to improve cleaning.

The pouches may include an optional cordlike material one connected to the first end slot and a second the second end slot with one end of each cord with a loop, when the cordlike material loop is pulled, the slot is closed ensuring that the contents remain secure inside during use. The slots create the pouches when used with the first end and the second end closed. The pouches act first as a pouch holding or soap or other cleaning materials, but also the pouches also acts as a handle, and also as glove when hands are inserted through the slots, that when closed form a pouch.

The device in another embodiment may create pouches in another way, The area where slots were with the preferred embodiment are sewn shut, and the first end and second end open, with a cordlike material with a loop connected to each end. Cleaning materials can then be inserted in the ends, and the cord like materials loop closed, creating a closed pouch.

The pouches are integrated into the main design, allowing them to be used simultaneously for storing items such as soap, as handles for enhanced control during use, and as gloves, providing multi-purpose functionality without relying on additional accessories.

### Other Features

The device may have a parallel to the edge internal cord like material, from the first end to the cord like material's terminal point at a second end sewn line. With one end of the cordlike material attached to the first end, and when the second end of the device is held, and the cordlike material pulled, the device is compressed and transformed into a compact and rounded ball shape, which can then be held in place by maneuvering the second end of the device around the compressed form of the device. The invention is applicable to a variety of materials that are appropriate for hygiene and exfoliation, as well as other general cleaning applications. This feature makes the device a “continuous transformation system” as it is very simple to transform the product from a flat state to a compact form with a single action.

### BRIEF DESCRIPTION OF DRAWINGS

FIG. 1 shows the device in its extended configuration with handles of cordlike materials and one slot with cordlike material with a loop that is around the slot that converts into a pouch when the loop on the cordlike material is pulled.

FIG. 2 shows the device pushed together so that it is bunched up in front of the slot.

FIG. 3 shows the device when second end of the device is maneuvered around the bunched up section of the device and encloses the bunched up section and the loop on the cordlike material from the second slot is on top of the ball and when pulled the slot opening closes to hold the ball together.

FIG. 4 shows the device with a first end slot with a cordlike material with a loop and the second end slot with a cordlike material with a loop so the device can have pouches on both ends for items like soap. Both the first end and the second end are closed.

FIG. 5 shows the device with the first end slot positioned somewhere in the bunch up material before the second end is maneuvered around the bunched up material

FIG. 6 shows the device with slight open indents between the first end slot and the first end and between the second end slot and the second end.

FIG. 7 shows hands within the first end slot and the second end slot. The hands are in the same area that serves as pouches when loop on the cordlike materials connected to the first end slot and the second end slot are pulled.

FIG. 8 shows the device with the first end slot sewn shut, and the second end slot sewn shut, and the first end and the second end open with each end having the cordlike material connected to each end with a loop that when each loop is pulled, the appropriate end closes and two pouches are closed.

FIG. 9 shows the device in the bunched up condition, with the cordlike material with loop, connected to the second end which is open.

FIG. 10 shows the device with the parallel to the edge cordlike material attached to the first end and then extending to the second end slot where it terminates. The figure also includes the cordlike material with a loop for closing the second end slot.

FIG. 11 shows the device when the cordlike device attached to the first end of the device is pulled toward the second end slot by pulling the cordlike material in the second slot resulting in a bunched up shape.

FIG. 12 shows the device with the cordlike material attached to the second slot, on the edge away from the second end, extending through the device to the outside of the first end where it has a loop. When the loop is pulled, while holding the first end, the device will end up in a bunched up condition.

FIG. 13 shows the bunched up condition that results after the loop outside the first is pulled away from the first end, while the first end is being held.

Note: the following figures are in sets of three, and they show how items in the pouches go into, and can be stored in the ball like configuration.

FIG. 14-FIG. 16 shows soap in the pouch with an open first end and a sewn area where slots are in other configurations. FIG. 14 shows soap going into the pouch, FIG. 15 shows where the first end is closed, and FIG. 16 show she soap within the ball like configuration.

FIG. 17-FIG. 19 shows soap going into the pouch through the first end slot and then into the ball like configuration. FIG. 17 shows the soap going into the slot, FIG. 18 shows the slot being closed by pulling the slot cordlike material loop, and FIG. 19 soap within the ball like configuration

FIG. 20-FIG. 22 shows how a hand in the open first end slot, with a closed first end, with soap, and how the soap goes into the ball like configuration. FIG. 20 shows the hand in the slot, FIG. 21 shows soap being placed into the slot with the hand, and FIG. 22 shows, once the hand is remove, the soap within the ball like configuration.

Note: FIG. 23 through FIG. 28 shows how the parallel to the edge cordlike material is contained within the ball like configuration after soap is added into the second end slot.

FIG. 23-FIG. 25 shows when cordlike material parallel to the edge and connected to second end slot has been pulled to bunch up the device has been placed within the second end slot with soap added. FIG. 23 show the device bunched up with the parallel to the edge cordlike material inserted into the slot, FIG. 24 shows soap being added onto the slot and FIG. 25 shows the final ball-like configuration.

FIG. 26-FIG. 28 Shows the parallel to the edge cordlike material before being in slot, to the process of pushing the parallel to the side cordlike material into the device second end slot. FIG. 26 shows the device bunched up with the parallel to the edge cordlike material outside the slot.

FIG. 27 shows soap being added to the slot and the parallel to the edge cordlike material being pushed through the slot and FIG. 29 shows the final ball like configuration.

### EXPLANATION OF FIGURES IN DRAWINGS

1. Device
2. Optional handles cordlike material on end of device.
3. Open first end of the device.
4. Closed second end of the device.
5. Second end slot on first side of the device.
6. A slot cordlike material and loop connected to the edge of the second end slot.
7. Bunched up section of device
8. Ball like configuration.
9. First end slot on first side of the device.
10. A slot cordlike material and loop connected to the edge of the first end slot.
11. Small open indents on the device.
12. A parallel to the side cordlike material within the device and with a semi-permanent attachment to the second slot.
13. Bunched like section of device created by pulling the cordlike material within the device towards the second end.
14. First end open with end cordlike material connected to the outside edge of the open end.
15. Second end open with end cordlike material connected to the outside edge of the open end.
16. A parallel to the side cordlike material within the device and with a permanent attachment to the second slot and a loop that extends out of the first end.
17. Bunched like section of device created by pulling the parallel to the side cordlike material within the device towards the first end while holding the first end.
18. Potential pouches
19. Hands
20. Parallel to the side cordlike material attached to the first end.
21. Open first end with the parallel to the side cordlike material and loop with the loop extending out of the first end.
22. First end slot without the slot cordlike material.
23. Top edge.
24. Bottom edge.
25. First end sewn slot.
26. Second end sewn slot.
27. Closed first end
28. Open second end
29. Soap

### DETAILED DESCRIPTION

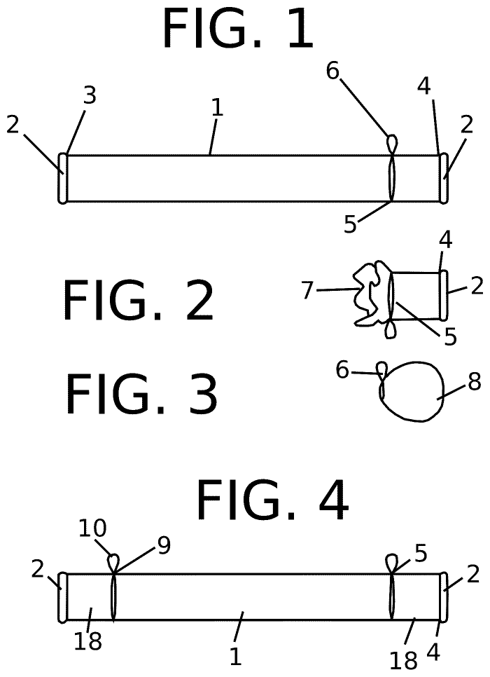

FIG. 1 shows the device 1 in its extended configuration with optional handles 2 of handle cordlike materials and the second end slot 5 with a loop on slot cordlike material 6, the material being connected around the second end slot 5.

FIG. 2 shows the device 1 pushed together so that it is bunched up 7 in front of the second end slot 5.

FIG. 3 shows the device 1 when the closed second end of the device 4 is maneuvered around the bunched up section 7 of the device 1 and encloses the bunched up section and the loop on the cordlike material on top of the ball from the second end slot 5 closes creating the ball like configuration 8. Alternatively the bunched up section 7 of the device 1 can be inserted into the second slot 5 and the cordlike material connected the second slot can be pulled and the ball like configuration 8 closed.

FIG. 4 shows the device 1 with optional handles 2 on the closed first end 27 and the closed second end 4. The first end slot with a cordlike material with a loop 10 and the second end slot with a cordlike material with a loop 6 so the device 1 can have pouches 18 on both ends for items like soap.

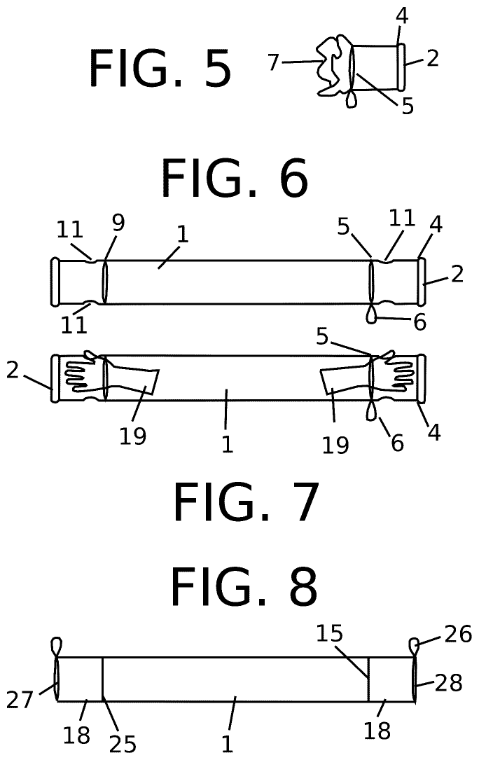

FIG. 5 shows the device 1 with the first end slot 9 positioned somewhere in the bunch up material before the closed second end 4 is maneuvered around the bunched up material the bunched up section 7 of the device 1 can be inserted into the second slot 5 and the cordlike material connected to the second slot can be pulled and the ball like configuration 8 closed. Alternatively the bunched up section 6 of the device 1 can be inserted into the second slot 5 and the cordlike material connected the second slot can be pulled and the ball like configuration 8 closed.

FIG. 6 shows the device 1 with slight open indents 11 on both the top edge 23 of the side and the bottom edge 24 of the device sides of the device 1 between the first end slot 9 and the closed first end 3 and between the second end slot 5 and the closed second end 3.

FIG. 7 shows hands 19 within the first end slot 9 and the second end slot 10 with the fingers extending through the open indents 10. This embodiment removes the possibility of pouches 18.

FIG. 8 shows the device 1 with the first end slot sewn shut 25, and the second end slot sewn shut 26, and the open first end 14 and the open second end open 15 with each end having the cordlike material sewn into each end with a loop that when each loop is pulled, the appropriate end closes.

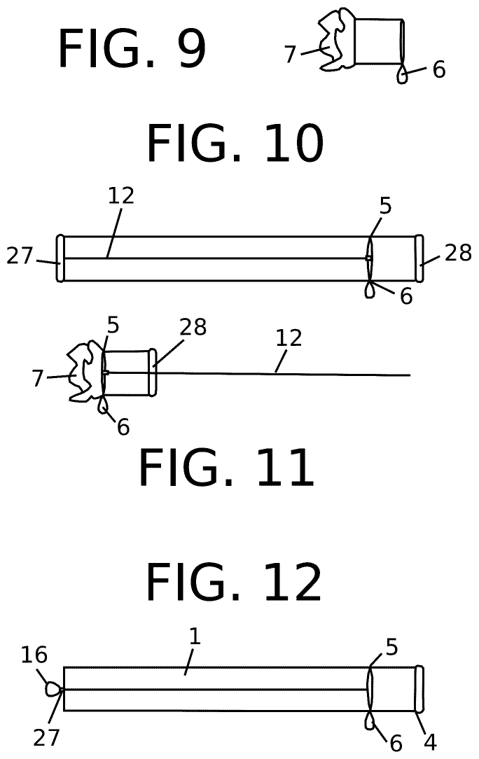

FIG. 9 shows the device 1 in the bunched up condition 7, with the slot cordlike material with loop, contained within the second end 14 which is open, the arrow shows how the area between the second end slot and the open second end 15 will fold over to make the device into a ball like configuration.

FIG. 10 shows the device 1 with the parallel to the side cordlike material attached to the first end 20 and then extending to the second end slot 5 with a semi-permanent connection 12 to the second slot. Also includes the cord like material with a loop 6 for closing the second slot.

FIG. 11 shows the device 1 when the parallel to the side cordlike material attached to the first end 20, of the device is pulled toward the second slot by pulling the parallel to the side cordlike material in the second end slot 5 towards the second end while holding the closed second end 4 resulting in a bunched up shape 7.

FIG. 12 shows the device with the cordlike material attached to the second slot, on the edge away from the second end, extending through the device to the outside of the first end where it has a loop that extends out of the open first end 12. When the loop is pulled, while holding the open first end 14, the device 1 will end up in a bunched up condition 7.

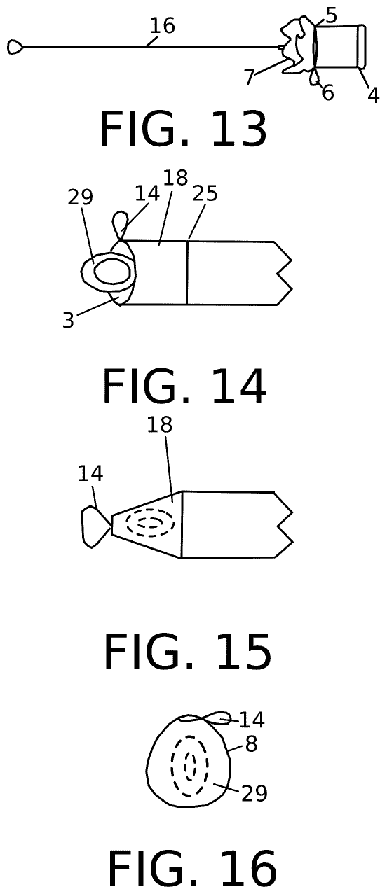

FIG. 13 shows the bunched up condition 7 that results after the loop from the parallel to the side cordlike material attached to the second end slot and extending out of the open first end 21 is pulled away from the open first end 14 first end, while the open first end 14 is being held.

FIG. 14-FIG. 16 shows soap 29 in the pouch 18 with an open first end 3 and a sewn area 25 where first end slots are in other configurations. FIG. 14 shows soap 29 going into the pouch 18, with the cordlike material attached to the first end 14 closed and the soap 29 within the pouch 18. FIG. 15 shows where the first open end 4 is closed by pulling the cordlike material attached to the first end, 14 and FIG. 16 show she soap 29 within the ball like configuration 8 with the cordlike material 14 attached to the first end pulled tight.

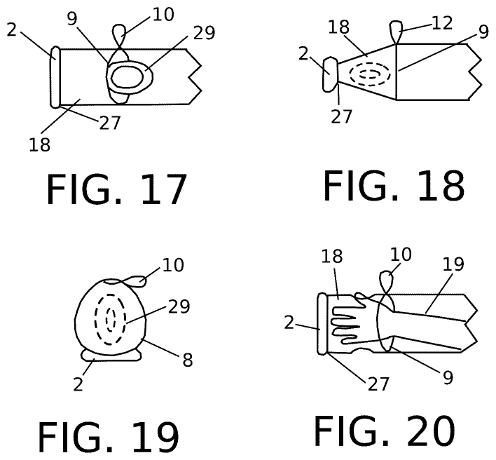

FIG. 17-FIG. 19 shows soap 29 going into the pouch 18 through the first end slot 9 and then into the ball like configuration 8. FIG. 17 shows the soap 29 going into the first end slot 9, FIG. 18 shows the first end slot 9 being closed by pulling the slot cordlike material loop 10, and FIG. 19 soap 29 within the ball like configuration 8.

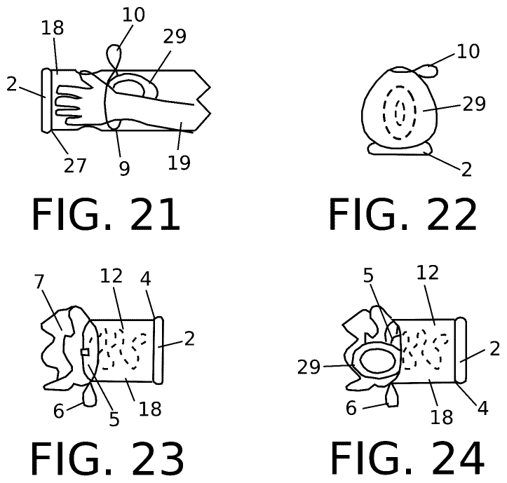

FIG. 20-FIG. 22 shows how a hand in the open first end slot 9, with a closed first end 27, with soap 29, and how the soap 29 goes into the ball like configuration 8. FIG. 20 shows the hand 19 in the first end slot 9. FIG. 21 shows soap 29 being placed into the first end slot 9 with the hand 19, and FIG. 22 shows, once the hand 19 is removed, the soap 29 within the ball like configuration 8.

FIG. 23-FIG. 25 shows when cordlike material parallel to the edge 12 and connected to second end slot 5 has been pulled to bunch up 7 the device has been placed within the second end slot 5 with soap added. FIG. 23 show the device bunched up 7 with the parallel to the edge cordlike material 12 inserted into the second end slot 5, FIG. 24 shows soap 29 being added onto the second end slot and FIG. 25 shows the final ball-like configuration 8, the soap 29 and the parallel to the edge cordlike material 12 into the second end slot and the slot cordlike material pulled 6 and the handle 2.

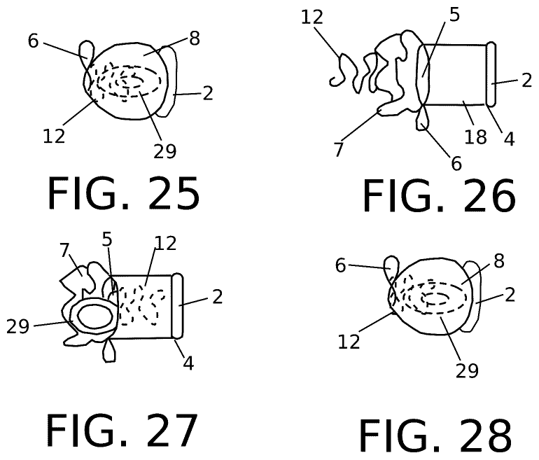

FIG. 26-FIG. 28 Shows the parallel to the edge cordlike material 12 before being in second end slot 5, to the process of pushing the parallel to the side cordlike material 12 into the second end slot. FIG. 26 shows the device bunched up 7 with the parallel to the edge cordlike material 12 outside the second end slot, FIG. 27 shows soap 29 being added to the second end slot 5 and the parallel to the edge cordlike material 12 being pushed through the second end slot 5 and FIG. 28 shows the final ball like configuration the soap 29 and the parallel to the edge cordlike material 12 into the second end slot and the slot cordlike material pulled 6 and the handle 2.

I claim:

1. A compressible cleaning device with pouch comprising:
a substantially tubular piece of scrubbing material having a top, a bottom, a first open end, a second closed end;
having a first edge and a second edge;
having a first end and a second end;
a length a minimum of five times the width of the first open end;
a first end sewn line connecting the top and bottom a distance from the first end;
a second sewn line connecting the top and bottom a distance from the second end;
a closed second end;
a second end open slot parallel to, between the sewn line and a closed second end;
a slot cordlike material connected to the second end slot with a loop extending away from the device;
wherein a second end pouch is created by the sewn line a distance from the second end and the closed second end creates a pouch and when the loop on the slot cordlike material is pulled the pouch is closed;
a parallel to the first edge cordlike material attached to the sewn line a distance from the second end, and extends out of the open first end, with a loop at the end of the slot cordlike material that leaves the open first end;
wherein when the parallel to the side cordlike material with a loop that extends out of the first open end is pulled while the second end is held, the device compresses into a bunched up shape, that can either be stuffed into the second end slot for a ball like configuration, or the closed second end can be maneuvered over the bunch up for a ball like configuration which is the secured as a ball by pulling the loop on the slot cordlike material connected to the second end slot.

2. The device of claim 1, where there is sewn line parallel to, and a distance from the first end, and a first end slot between the first end and the sewn line parallel to the first end and with a cordlike material attached to first end slot, with the parallel to the side cordlike material removed;
wherein a first end pouch is created.

3. The device of claim 2 with two open ends, with cordlike material connected to both or one of a first open end and the second open end, the cordlike material with a loop extending away from the first open end and the second open end, with the first end slot and second end slot removed;
wherein pouches are created between the first end sewn line and open first end and the second sewn line and second open end, when the open ends are closed by pulling the cordlike material.

4. The device of claim 1 without the parallel to the side cordlike material.

5. The device of claim 1 with a first sewn line and a first end slot with cordlike material connected to the device with the first end slot with a loop extending away from the device;
wherein the distance between the first closed end and the first end slot, and second end slot and the second open end can both be pouches for soap or other cleaning materials.

6. The device of claim 2 with open indents on both the top edge of the device and bottom edge of the device, the indents being between the first closed end and the first end slot, and between the second end slot and the second closed end;
wherein hands can be inserted into the first end slot and the second end slot and fingers or thumbs may come out of the slots.

7. The device of claim 2 where a parallel to the side cordlike material attached to a first closed end extends to the second slot with a semi-permanent attachment;
wherein when the parallel to the side cordlike material is detached from the second end slot and pulled away from the device while holding the second end, the device will compress into a bunched up state.
